(19) United States
(12) Patent Application Publication
(10) Pub. No.: US 2015/0211423 A1
(43) Pub. Date: Jul. 30, 2015

(54) AIR INLET SYSTEM OF ENGINE

(71) Applicant: Tzu-Nan CHUANG, CHANGHUA COUNTY (TW)

(72) Inventor: Tzu-Nan CHUANG, CHANGHUA COUNTY (TW)

(21) Appl. No.: 14/680,067

(22) Filed: Apr. 7, 2015

Related U.S. Application Data
(63) Continuation-in-part of application No. 13/540,631, filed on Jul. 3, 2012.
Application No. 13/540,631 is a continuation-in-part of application No. 12/695,149, filed on Jan. 27, 2010, now Pat. No. 8,280,615.

(51) Int. Cl. F02D 9/10; F02D 41/18; F02D 41/00

(52) U.S. Cl. CPC F02D 9/10; F02D 41/0002; F02D 41/18

(57) ABSTRACT

An air inlet system of an engine includes a throttle, a fan frame, a fan, a valve, a motor, and a throttle sensor. The fan frame has a hole exposed toward outside of the air inlet system. The fan is connected to the throttle and mounted into the fan frame behind the hole. The valve is mounted to the hole. The motor is for driving the fan to force air into at least one intake manifold of the engine through the throttle and is for driving the valve open. The throttle sensor is for controlling the rotational speed of the fan according to the motion of a throttle pedal.

### RELATED APPLICATIONS

The present application is a continuation-in-part of the application Ser. No. 13/540,631 filed on Jul. 3, 2012, which is a continuation-in-part of the application Ser. No. 12/695,149, filed on Jan. 27, 2010, the entire contents of which are hereby incorporated herein by reference.

### BACKGROUND

1. Technical Field

The present disclosure relates to fluid handling devices.

2. Description of Related Art

A standard air intake works by sucking warm air into the engine, which it can then use to oxygenate the gas inside of it. Of course, this is done to cause an ignition, providing the power the engine needs to run. Common air intakes may be fairly long, with several twists or chambers to help stifle their loud sound. While a quieter engine is probably ideal for most people, others are not satisfied with stock air intakes, most of which do not take full advantage of a vehicle's potential horsepower.

### SUMMARY

According to one embodiment, an air inlet system of an engine includes a throttle, a fan frame, a fan, a valve, a motor, a throttle sensor, a mass airflow sensor and a temperature detect switch. The fan frame has a hole and the hole is exposed toward outside of the air inlet system. The fan is connected to the throttle and mounted into the fan frame behind the hole. The valve is mounted to the hole. The motor can drive the fan to force air into at least one intake manifold of the engine through the throttle and can drive the valve open. The motor includes an air intake device, an air input hole and an air output hole. The air intake device can force air into the motor through the air input hole and exhaust air from the motor through the air output hole. The throttle sensor can control the rotational speed of the fan, an amount of air passing through the air intake device and an opening of the valve which is opened by the motor according to the motion of a throttle pedal. The mass airflow sensor can control the rotational speed of the fan, the amount of air passing through the air intake device and the opening of the valve according to an amount of air flow passing through the intake manifold of the engine. The temperature detect switch can control the rotational speed of the fan, the amount of air passing through the air intake device and the opening of the valve according to a temperature in the intake manifold of the engine.

According to another embodiment, an air inlet system of an engine includes a throttle, a fan frame, a fan, a valve, a motor, a throttle sensor, a mass airflow sensor, a temperature detect switch and a vehicle speed sensor. The throttle includes a throttle body, a throttle plate, and at least one throttle linkage. The throttle plate is housed in the throttle body. The throttle linkage connects the throttle plate to a throttle cable. The fan frame has a hole and the hole is exposed toward outside of the air inlet system. The fan is connected to the throttle and mounted into the fan frame behind the hole. The valve is mounted to the hole. The motor can drive the fan to force air into at least one intake manifold of the engine through the throttle and can drive the valve open. The motor includes an air intake device, an air input hole and an air output hole. The air intake device can force air into the motor through the air input hole and exhaust air from the motor through the air output hole. The throttle sensor can control the rotational speed of the fan, an amount of air passing through the air intake device and an opening of the valve which is opened by the motor according to the motion of the throttle plate of the throttle. The mass airflow sensor can control the rotational speed of the fan, the amount of air passing through the air intake device and the opening of the valve according to an amount of air flow passing through the intake manifold of the engine. The temperature detect switch can control the rotational speed of the fan, the amount of air passing through the air intake device and the opening of the valve according to a temperature in the intake manifold of the engine. The vehicle speed sensor for controlling the rotational speed of the fan, the amount of air passing through the air intake device and the opening of the valve according to a speed of a car carrying the engine.

### BRIEF DESCRIPTION OF THE DRAWINGS

FIG. 1 is a perspective view of an air inlet system of an engine according to one embodiment;

FIG. 2 is partial schematic diagram of the air inlet system of FIG. 1;

FIG. 3 is a perspective view of an air inlet system of an engine according to another embodiment;

FIG. 4 is a partial schematic diagram of the air inlet system of FIG. 3;

FIG. 5 is a functional block diagram of the throttle sensor according to one embodiment;

FIG. 6 is a sectional view of the throttle according to one embodiment;

FIG. 7 is a functional block diagram of the air inlet system of the engine according to one embodiment.

### DETAILED DESCRIPTION

In the following detailed description, for purposes of explanation, numerous specific details are set forth in order to provide a thorough understanding of the disclosed embodiments. It will be apparent, however that one or more embodiments may be practiced without these specific details. In other instances, well-known structures and devices are schematically depicted in order to simplify the drawings.

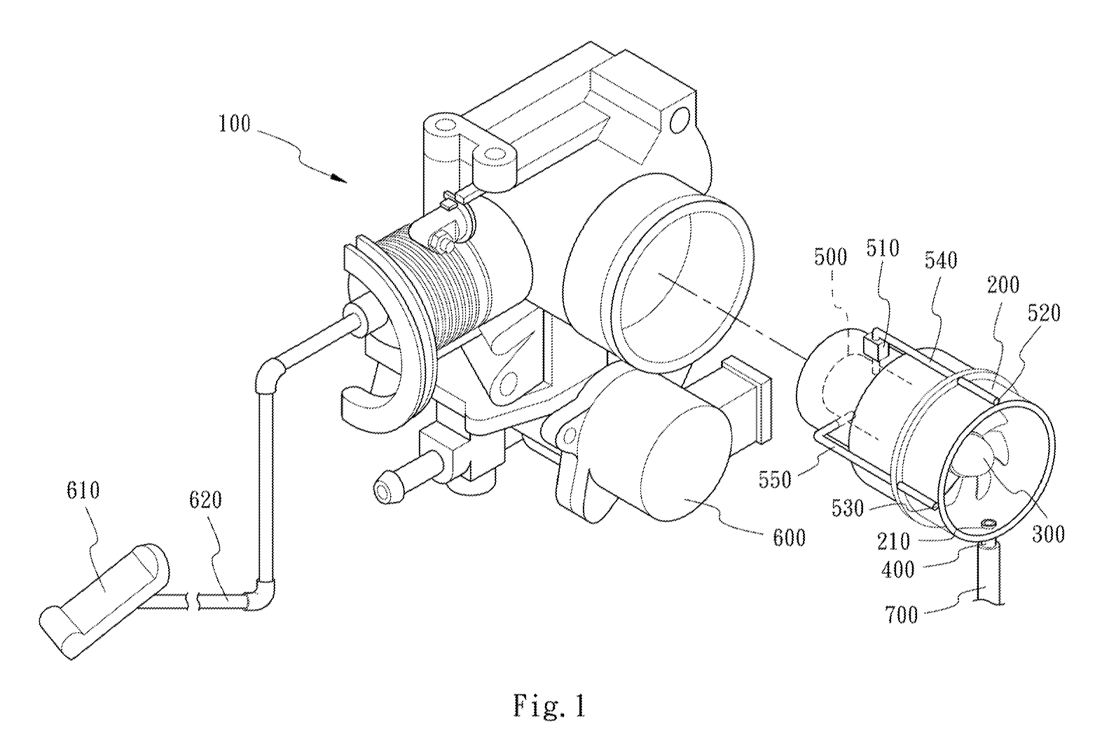

FIG. 1 is a perspective view of an air inlet system of an engine according to one embodiment. The air inlet system of the engine includes a throttle 100, a fan frame 200, a fan 300, a valve 400, a motor 500, a throttle sensor 600, and a recycled exhaust gas supply tube 700. The fan frame 200 has a hole 210 and the hole 210 is exposed toward outside of the air inlet system. The fan 300 is connected to the throttle 100 and mounted into the fan frame 200. The fan 300 is behind the hole 210. The valve 400 is mounted to the hole 210. The motor 500 can drive the fan 300 to force air into at least one intake manifold of the engine through the throttle 100 and can drive the valve 400 open. In addition, the motor 500 includes an air intake device 510, an air input hole 520, an air output hole 530, an intake tube 540 and an exhaust tube 550. The air intake device 510 can force air into the motor 500 through the air input hole 520 and exhaust air from the motor 500 through the air output hole 530. Hence, the temperature of the motor 500 can be lowered to further improve its operational efficiency. The throttle sensor 600 can control the rotational speed of the fan 300, an amount of air passing through the air intake device 510 and an opening of the valve 400 which is opened by the motor 500 according to the motion of a throttle pedal 610. The recycled exhaust gas supply tube 700 is connected to the valve 400 for supplying the recycled exhaust gas into the hole 210. Moreover, the air intake device 510 is connected to the body of the motor 500 and the sidewall of the fan frame 200 by the intake tube 540. The air input hole 520 at one end of the intake tube 540 is in front of the fan 300. The body of the motor 500 is connected to the air output hole 530 by the exhaust tube 550. The air output hole 530 at one end of the exhaust tube 550 is also in front of the fan 300.

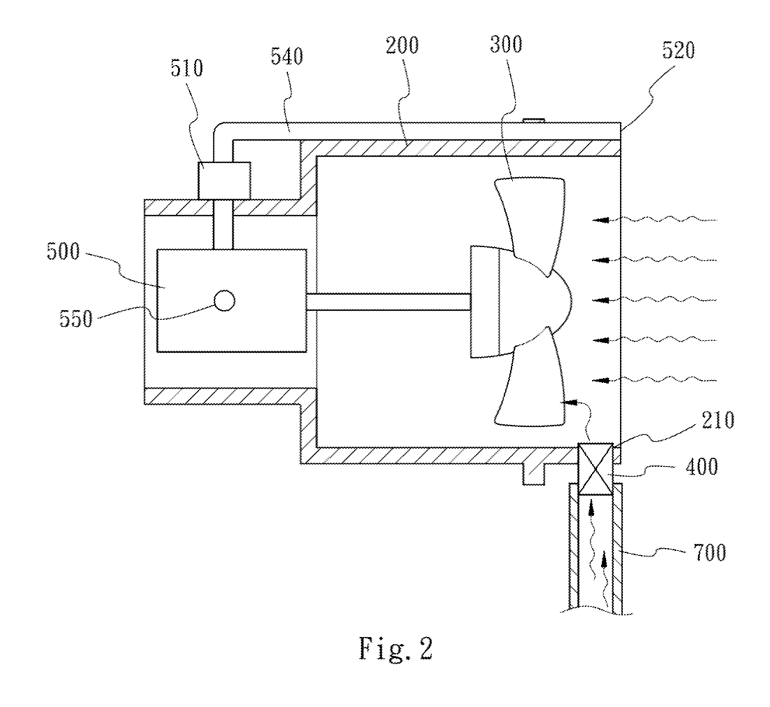

FIG. 2 is partial schematic diagram of the air inlet system of FIG. 1. The hole 210 is drilled in the sidewall of the fan frame 200 and is in front of the fan 300. The valve 400 is mounted to the hole 210 and connects the fan frame 200 and the recycled exhaust gas supply tube 700. The recycled exhaust gas from the recycled exhaust gas supply tube 700 is introduced into the hole 210 through the opening the valve 400 releases. The air intake device 510 is connected to the body of the motor 500 and the sidewall of the fan frame 200 by the intake tube 540. The air input hole 520 at one end of the intake tube 540 is in front of the fan 300.

In use, the air and fuel can be mixed well because the rotational speed of the fan 300 and the opening the valve 400 releases are controlled according to the motion of the throttle pedal 610. Also, the recycled exhaust gas is introduced into the hole 210 through the opening of the valve 400 and is sucked by the fan 300. Thus, the engine can run more smoothly under the condition of oxygen deficiency or when starting.

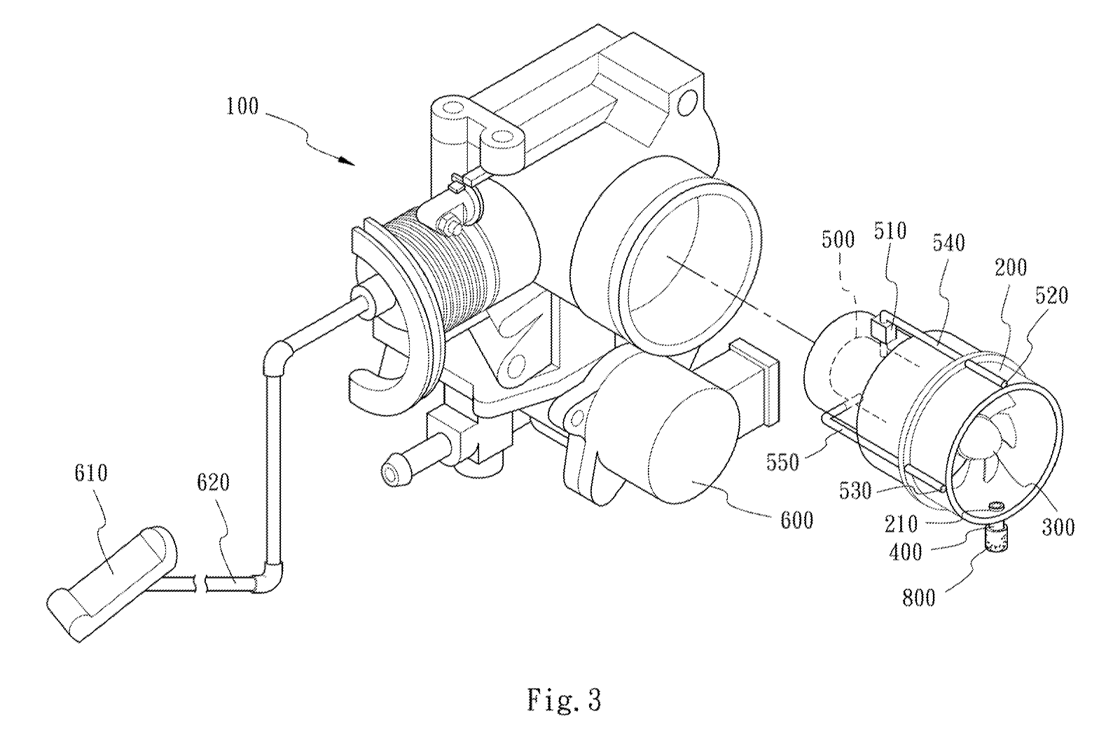

FIG. 3 is a perspective view of an air inlet system of an engine according to another embodiment. The air inlet system of the engine includes a throttle 100, a fan frame 200, a fan 300, a valve 400, a motor 500, a throttle sensor 600, and an air filter 800. The fan frame 200 has a hole 210 and the hole 210 is exposed toward outside of the air inlet system. The fan 300 is connected to the throttle 100 and mounted into the fan frame 200. The fan 300 is behind the hole 210. The valve 400 is mounted to the hole 210. The motor 500 can drive the fan 300 to force air into at least one intake manifold of the engine through the throttle 100 and can drive the valve 400 open. Moreover, the motor 500 includes an air intake device 510, an air input hole 520, an air output hole 530, an intake tube 540 and an exhaust tube 550. The air intake device 510 can force air into the motor 500 through the air input hole 520 and exhaust air from the motor 500 through the air output hole 530. Therefore, the temperature of the motor 500 can be lowered to further improve its operational efficiency. The throttle sensor 600 can control the rotational speed of the fan 300 the amount of air passing through the air intake device 510 and the opening of the valve 400 which is opened by the motor 500 according to the motion of a throttle pedal 610. The air filter 800 is put on the valve 400 for preventing particles in the air outside the air inlet system from entering the valve 400. Furthermore, the operation of the air intake device 510 can be controlled by the rotational speed of the fan 300.

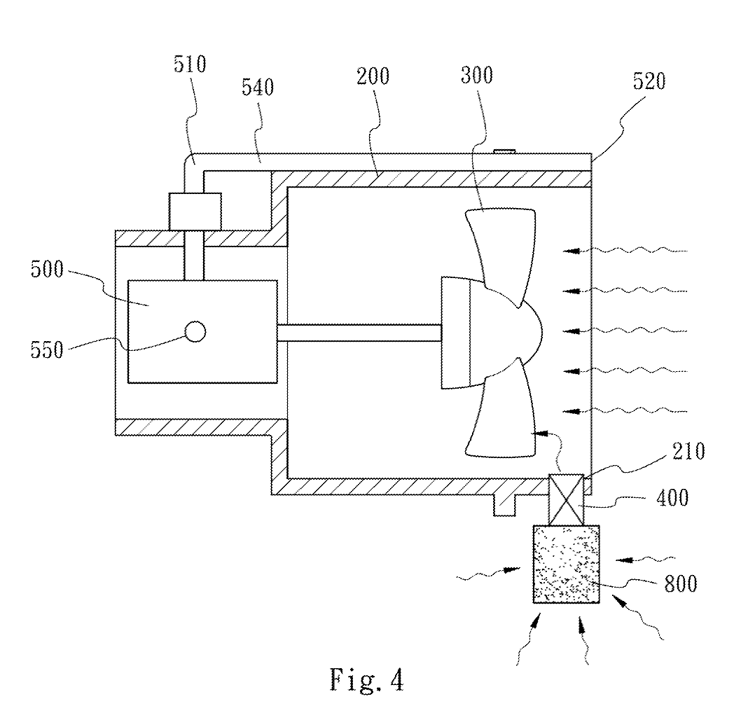

FIG. 4 is a partial schematic diagram of the air inlet system of FIG. 3. The hole 210 is drilled in the sidewall of the fan frame 200 and is in front of the fan 300. The valve 400 is mounted to the hole 210 and put on the air filter 800. The air outside the air inlet system is sucked by the fan 300 through the opening the valve 400 releases and is filtrated before entering the valve 400. The air intake device 510 is connected to the body of the motor 500 and the sidewall of the fan frame 200 by the intake tube 540. The air input hole 520 at one end of the intake tube 540 is in front of the fan 300.

In use, the air and fuel can be mixed well because the rotational speed of the fan 300 and the opening the valve 400 releases are controlled according to the motion of the throttle pedal 610. Also, the air outside the air inlet system is sucked by the fan 300 and filtrated by the air filter 800. Thus, the engine can run more smoothly under the condition of oxygen deficiency or when starting.

In one or more embodiment, the motor 500 may be a brushless motor or the following reasons. First, the brushless motor has a small size, such that air can flow through a larger area without being blocked by the motor 500. Second, the brushless motor has a longer lifetime (no brush erosion). On the other hand, the energy consumption of the brushless motor is less than a turbine supercharger, so the air inlet system of the engine can be assembled to almost all kind of cars.

More particularly, the motor 500 may be a continuously variable speed motor. Accordingly, the car will have a better acceleration performance.

The valve 400 may be a solenoid valve or a mechanical valve. The valve 400 can be controlled by the motor 500 driven according to the motion of the throttle pedal 610. The throttle sensor 600 can control the rotational speed of the fan 300 according to the motion of the throttle pedal 610. That is, at the same time of stepping on the throttle pedal 610, the fan 300 shows relative rotational speed according to the motion of a throttle pedal 610 and also the valve 400 releases a relative opening according to the motion of a throttle pedal 610. In other words, the larger the motion of the throttle pedal 61Q the faster the fan 300 rotates and the bigger opening the valve 400 releases.

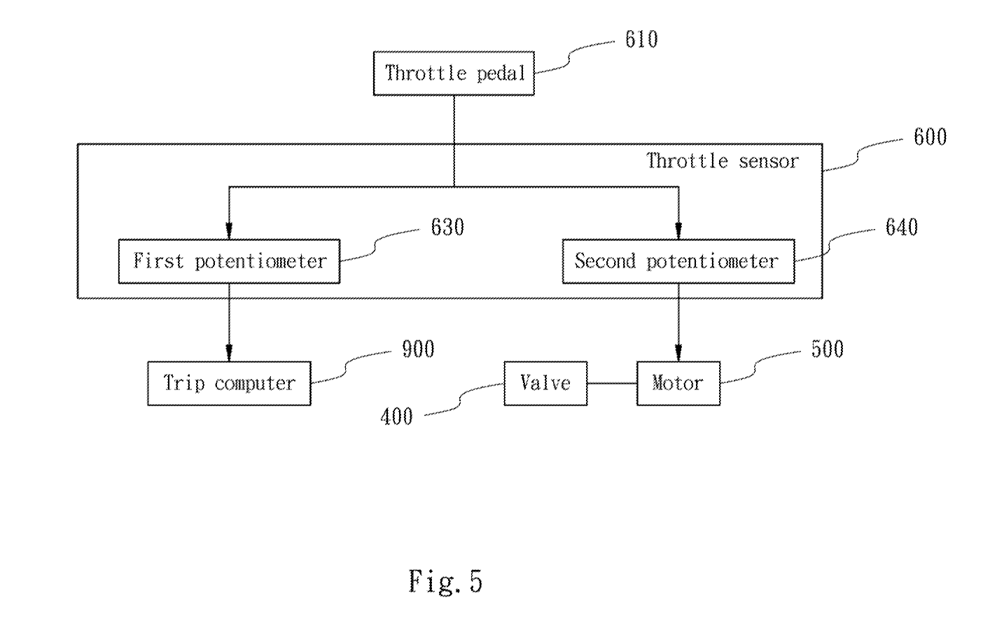

FIG. 5 is a functional block diagram of the throttle sensor according to one embodiment. The throttle sensor 600 has a first potentiometer 630 and a second potentiometer 640. The first potentiometer 630 is communicated with the throttle pedal 610 for providing the motion of the throttle pedal 610 to a trip computer 900. The second potentiometer 640 is communicated with the throttle pedal 610 for controlling the rotational speed of the fan 300, the amount of air passing through the air intake device 510 and the opening of the valve 400 by the motor 500 according to the motion of the throttle pedal 610. Thus, separating the signal of the trip computer 900 and the motor 500 not only avoids the signal interference but reinforces the signal strength. Furthermore, the valve 400 opens as the motor 500 works and closes as the motor stops.

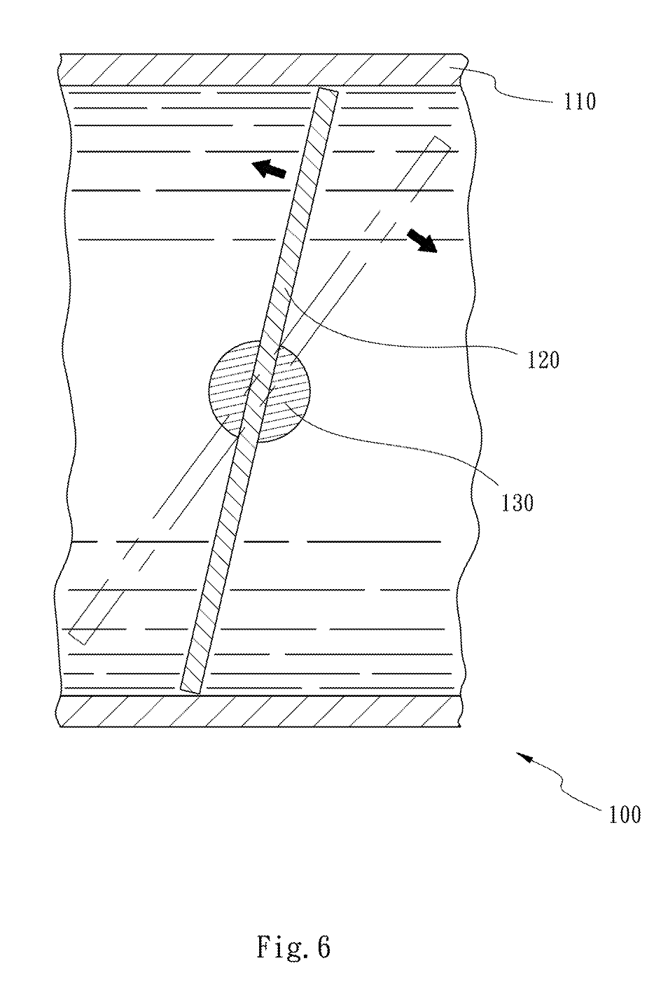

FIG. 6 is a sectional view of the throttle according to one embodiment. The throttle 100 includes a throttle body 110, a throttle plate 120, and a throttle linkage 130.

The throttle plate 120 is housed in the throttle body 110. The throttle linkage 130 is connecting the throttle plate 120 to a throttle cable 620. The throttle cable 620 connects the throttle pedal 610 to the throttle linkage 130, and the throttle sensor 600 is connected to the throttle linkage 130. At the same time of stepping on the throttle pedal 610, the fan 300 shows relative rotational speed according to the opening degree of the throttle plate 120. That is, the throttle sensor 600 can control the rotational speed of the fan 300 according to the motion of the throttle plate 120.

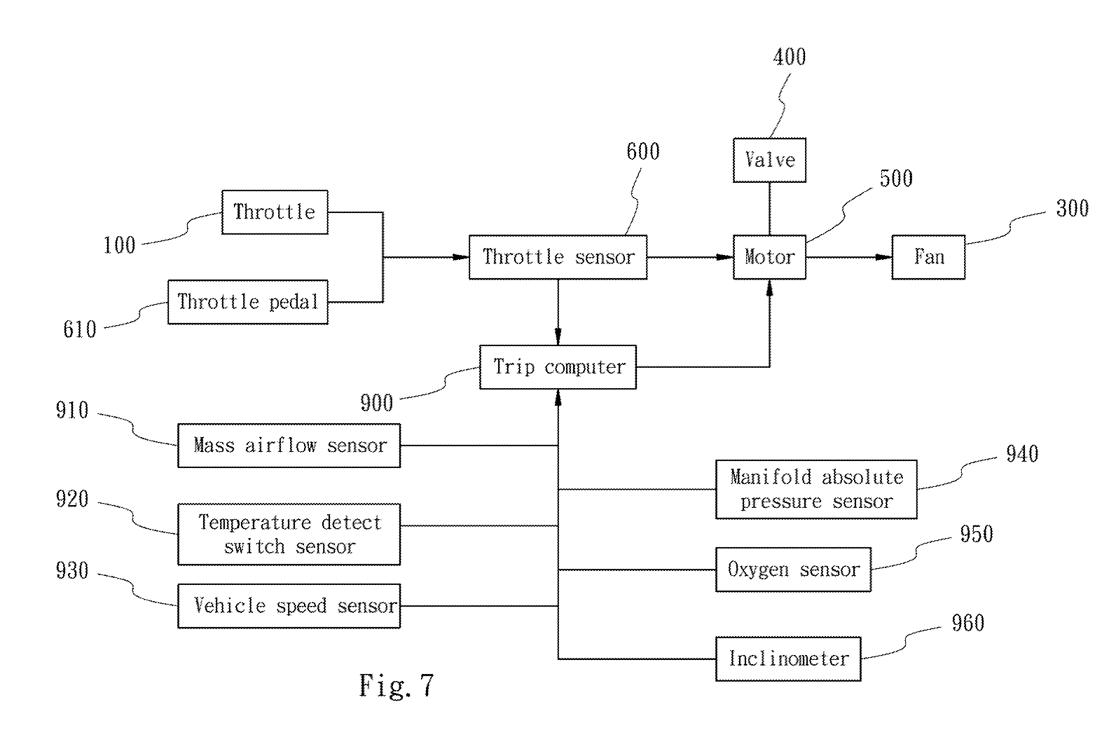

FIG. 7 is a functional block diagram of the air inlet system of engine according to one embodiment. The air inlet system of the engine includes a trip computer 900. The trip computer 900 adjusts the rotational speed of the fan 300, the amount of air passing through the air intake device 510 and the opening of the valve 400 according to the data in the trip computer 900. In addition to cut down the time of adjusting the rotational speed of the fan 300 but raise the efficiency of the engine as well.

The trip computer 900 is programmed to adjust the rotational speed of the fan 300, the amount of air passing through the air intake device 510 and the opening of the valve 400 according to the rotational speed of the engine, the speed of a car carrying the engine, and/or whether combustion in the engine is complete or not. On the other hand, by assembling the extra sensors, such as a mass airflow (MAF) sensor 910 detects the amount of air flow passing through the intake manifold of the engine, a temperature detect switch (TDS) 920 detects a temperature of the intake manifold of the engine, a vehicle speed sensor (VSS) 930 detects a speed of a car carrying the engine, a manifold absolute pressure (MAP) sensor 940 detects the pressure of the intake manifold of the engine, a oxygen sensor 950 detects oxygen concentration in the exhaust manifold of the engine and an inclinometer 960 detects the tilt angle of the car carrying the engine.

In addition, the mass airflow sensor 910 connects the trip computer 900 to control the rotational speed of the fan 300, the amount of air passing through the air intake device 510 and the opening of the valve 400 according to the amount of air flow passing through the intake manifold of the engine. The temperature detect switch 920 connects the trip computer 900 to control the rotational speed of the fan 300, the amount of air passing through the air intake device 510 and the opening of the valve 400 according to the temperature in the intake manifold of the engine. The vehicle speed sensor 930 connects the trip computer 900 to control the rotational speed of the fan, the amount of air passing through the air intake device and the opening of the valve according to the speed of a car carrying the engine. The manifold absolute pressure 940 connects the trip computer 900 to control the rotational speed of the fan 300, the amount of air passing through the air intake device 510 and the opening of the valve 400 according to the pressure of the intake manifold of the engine. Therefore, the trip computer 900 adjusts the rotational speed of the fan 300, the amount of air passing through the air intake device 510 and the opening of the valve 400 by reading in the data of the extra sensors.

TABLE 1

| Rotational speed of | Consumptive current of | Energy consumption of |
|---|---|---|
| the engine (rpm) | the motor (A) | the motor (W) |
| Below 1500 | 0 | 0 |
| 1500~2000 | 8 | 104 |
| 2000 | 12 | 144 |
| 3000 | 20 | 260 |

According to the data in the table 1, the motor 500 does not operate when the rotational speed of the engine is below 1500 rpm. Therefore, the motor 500 of the air inlet system of the engine does not affect the original efficiency of the car. The motor 500 needs 104 W and 8 A when the rotational speed of the engine is between 1500 rpm to 2000 rpm. The motor 500 needs 144 W and 12 A when the rotational speed of the engine is around 2000 rpm. The motor 500 needs 260 W and 20 A when the rotational speed of the engine is around 3000 rpm. To sum up, only when the car suddenly accelerated or drives on the mountain, in other words, when the rotational speed of the engine is beyond 1500 rpm, the motor 500 starts to operate. The motor 500 adjusts the rotational speed of the fan 300, the amount of air passing through the air intake device 510 and the opening of the valve 400 to reach the best condition of the engine by reading in the data of the rotational speed of the engine.

Applying the air inlet system of the engine not only increases the filling rate of air but also gets a greater quantity of air because the hole 210 drilled in the sidewall of the fan frame 200 provides a channel for further introducing air or recycled exhaust gas. Accordingly, the engine applying the air inlet system can run smoothly under the condition of oxygen deficiency or when starting. The brushless motor has a longer lifetime (no brush erosion). It is more convenient to assemble the air inlet system of the engine in all kinds of cars. Moreover, the throttle sensor 600 controls the rotational speed of the fan 300, the amount of air passing through the air intake device 510 and the opening of the valve 400 directly, not only avoids the signal interference with the trip computer 900 but also reinforces the signal strength.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An air inlet system of an engine, comprising:
a throttle;
a fan frame having a hole exposed toward outside of the air inlet system;
a fan connected to the throttle and mounted into the fan frame behind the hole;
a valve mounted to the hole;
a motor for driving the fan to force air into at least one intake manifold of the engine through the throttle and for driving the valve open, wherein the motor comprises an air intake device, an air input hole and an air output hole, and the air intake device is for forcing air into the motor through the air input hole and for exhausting air from the motor through the air output hole;
a throttle sensor for controlling a rotational speed of the fan, an amount of air passing through the air intake device and an opening of the valve which is opened by the motor according to a motion of a throttle pedal;
a mass airflow sensor for controlling the rotational speed of the fan, the amount of air passing through the air intake device and the opening of the valve according to an amount of air flow passing through the intake manifold of the engine; and
a temperature detect switch for controlling the rotational speed of the fan, the amount of air passing through the air intake device and the opening of the valve according to a temperature in the intake manifold of the engine.

2. The air inlet system of the engine of claim 1, further comprising:
a recycled exhaust gas supply tube connected to the valve.

3. The air inlet system of the engine of claim 1, further comprising:
an air filter put on the valve.

4. The air inlet system of the engine of claim 1, wherein the throttle comprises:
a throttle body;
a throttle plate housed in the throttle body; and
at least one throttle linkage connecting the throttle plate to a throttle cable, wherein the throttle cable connects the throttle pedal to the throttle linkage, and the throttle sensor is connected to the throttle linkage.

5. The air inlet system of the engine of claim 1, wherein the throttle sensor comprises:
a first potentiometer communicated with the throttle pedal for providing the motion of the throttle pedal to a trip computer; and
a second potentiometer communicated with the throttle pedal for controlling the rotational speed of the fan, the amount of air passing through the air intake device and the opening of the valve according to the motion of the throttle pedal.

6. The air inlet system of the engine of claim 1, further comprising:
a trip computer programmed to adjust the rotational speed of the fan, the amount of air passing through the air intake device and the opening of the valve according to the rotational speed of the engine.

7. The air inlet system of the engine of claim 1, further comprising:
a vehicle speed sensor for detecting a speed of a car carrying the engine; and
a trip computer programmed to adjust the rotational speed of the fan, the amount of air passing through the air intake device and the opening of the valve according to the speed of a car carrying the engine.

8. The air inlet system of the engine of claim 1, further comprising:
a manifold absolute pressure sensor for detecting the pressure of the intake manifold of the engine; and
a trip computer programmed to adjust the rotational speed of the fan, the amount of air passing through the air intake device and the opening of the valve according to the pressure of the intake manifold of the engine.

9. The air inlet system of engine of claim 1, further comprising:
a trip computer programmed to adjust the rotational speed of the fan, the amount of air passing through the air intake device and the opening of the valve according to whether combustion in the engine is complete or not.

10. The air inlet system of engine of claim 1, further comprising:
an oxygen sensor for detecting oxygen concentration in at least one exhaust manifold of the engine; and
a trip computer programmed to adjust the rotational speed of the fan, the amount of air passing through the air intake device and the opening of the valve according to the oxygen concentration in the exhaust manifold of the engine.

11. The air inlet system of the engine of claim 1, further comprising:
an inclinometer for detecting the tilt angle of a car carrying the engine; and
a trip computer programmed to adjust the rotational speed of the fan, the amount of air passing through the air intake device and the opening of the valve according to the tilt angle of the car carrying the engine.

12. An air inlet system of an engine, comprising:
a throttle comprising:
a throttle body;
a throttle plate housed in the throttle body; and
at least one throttle linkage connecting the throttle plate to a throttle cable:
a fan frame having a hole exposed toward outside of the air inlet system;
a fan connected to the throttle and mounted into the fan frame behind the hole;
a valve mounted to the hole;
a motor for driving the fan to force air into at least one intake manifold of the engine through the throttle and for driving the valve open, wherein the motor comprises an air intake device, an air input hole and an air output hole, and the air intake device is for forcing air into the motor through the air input hole and for exhausting air from the motor through the air output hole;
a throttle sensor for controlling a rotational speed of the fan, an amount of air passing through the air intake device and an opening of the valve which is opened by the motor according to a motion of the throttle plate of the throttle;
a mass airflow sensor for controlling the rotational speed of the fan, the amount of air passing through the air intake device and the opening of the valve according to an amount of air flog passing through the intake manifold of the engine;
temperature detect switch for controlling the rotational speed of the fan, the amount of air passing through the air intake device and the opening of the valve according to a temperature in the intake manifold of the engine; and
a vehicle speed sensor for controlling the rotational speed of the fan, the amount of air passing through the air intake device and the opening of the valve according to a speed of a car carrying the engine.

13. The air inlet system of the engine of claim 12, further comprising:
a recycled exhaust gas supply tube connected to the valve.

14. The air inlet system of the engine of claim 12, further comprising:
an air filter put on the valve.

15. The air inlet system of the engine of claim 12, wherein the throttle sensor comprises:
a first potentiometer communicated with a throttle pedal for providing the motion of the throttle pedal to a trip computer; and
a second potentiometer communicated with the throttle pedal for controlling the rotational speed of the fan, the amount of air passing through the air intake device and the opening of the valve according to the motion of a throttle pedal.

16. The air inlet system of the engine of claim 12, further comprising:
a trip computer programmed to adjust the rotational speed of the fan, the amount of air passing through the air intake device and the opening of the valve according to the rotational speed of the engine.

17. The air inlet system of the engine of claim 12, further comprising:
a manifold absolute pressure sensor for detecting the pressure of the intake manifold of the engine; and
a trip computer programmed to adjust the rotational speed of the fan, the amount of air passing through the air intake device and the opening of the valve according to the pressure of the intake manifold of the engine.

18. The air inlet system of the engine of claim 12, further comprising:
a trip computer programmed to adjust the rotational speed of the fan, the amount of air passing through the air intake device and the opening of the valve according to whether combustion in the engine is complete or not.

19. The air inlet system of the engine of claim 12, further comprising:
an oxygen sensor for detecting oxygen concentration in at least one exhaust manifold of the engine; and
a trip computer programmed to adjust the rotational speed of the fan, the amount of air passing through the air intake device and the opening of the valve according to the oxygen concentration in the exhaust manifold of the engine.

20. The air inlet system of the engine of claim 12, further comprising:
an inclinometer for detecting the tilt angle of a car carrying the engine; and
a trip computer programmed to adjust the rotational speed of the fan, the amount of air passing through the air intake device and the opening of the valve according to the tilt angle of the car carrying the engine.
